(19) United States
(12) Patent Application Publication
(10) Pub. No.: US 2009/0018229 A1
(43) Pub. Date: Jan. 15, 2009

(54) Nanocomposites prepared using nanoadditive containing dispersed silicate layers or inorganic nanoparticles

(76) Inventors: Dotsevi Y. Sogah, Ithaca, NY (US); Jianbo Di, Evansville, IN (US); Xiao-Ping Chen, Bellmore, NY (US)

Correspondence Address: BACON & THOMAS, PLLC, 625 SLATERS LANE, FOURTH FLOOR, ALEXANDRIA, VA, 22314-1176, US

(21) Appl. No.: 11/665,050

(22) PCT Filed: Nov. 9, 2005
(86) PCT No.: PCT/US05/40612

§ 371 Date: Apr. 11, 2007

Related U.S. Application Data
(60) Provisional application No. 60/628,168, filed on Nov. 17, 2004.

(51) Int. Cl. C08K 3/34; C08L 25/06; C08L 53/02; C08L 23/26; C08L 33/10

(52) U.S. Cl. 522/51; 525/241; 525/98; 525/240; 525/227

(57) ABSTRACT

Nanocomposites of silicate layers or inorganic nanoparticles dispersed in a polymer or copolymer matrix are prepared by solution blending or melt blending the polymer or copolymer with nanoadditive containing from 20 to 50 weight percent silicate layers or inorganic nanoparticles dispersed in a different polymer or copolymer of Mₙ ranging form 10,000 to 40,000.

### CROSS-REFERENCE TO RELATED APPLICATIONS

This application claims the benefit of U.S. Provisional Application No. 60/628,168, filed Nov. 17, 2004, the whole of which is incorporated herein by reference.

The invention was made at least in part with United States Government support under National Science Foundation Grant Numbers DMR-0079992, DMR-9632275 and DMR-8314255. The United States Government has certain rights in the invention.

### TECHNICAL FIELD

The invention is directed at preparation of nanocomposites of polymer and dispersed silicate layers or dispersed inorganic nanoparticles and at the nanocomposites prepared thereby.

### BACKGROUND OF THE INVENTION

Nanocomposites of polymer and silicate (either intercalated or dispersed) have been obtained by first preparing a masterbatch that is more readily obtained and then using it to prepare other nanocomposites that are otherwise more difficult to prepare; this allows accommodating for the incompatibility between the polymer matrix (hydrophobic) and silicate layers (hydrophilic). Known processes do not guarantee the dispersion of the silicate layers in the final product.

### SUMMARY OF THE INVENTION

It has been discovered herein that by blending nanoadditive where polymer chains are attached to silicate layers or inorganic nanoparticles, with other polymers, dispersion of the silicate layers or inorganic nanoparticles in the final product, is promoted. The method has broad application scope allowing preparation of previously unavailable dispersed nanocomposites and replaces the problem of incompatibility between polymer and silicate layers or inorganic nanoparticles with the readily treatable circumstance of controlling interaction between polymer (of the nanoadditive) and polymer (of the matrix) and allows preparation of nanoadditive which can be obtained from a variety of monomers.

In a first embodiment, the invention herein is directed to a method of preparing a nanocomposite comprising from 0.1 to 25.0% by weight silicate layers or inorganic nanoparticles, very preferably 0.1 to 5.0% silicate layers or nanoparticles, dispersed in a matrix of a first polymer or copolymer of Mₙ ranging from 5,000 to 400,000, said method comprising the steps of melt blending or solution blending the first polymer with a silicate layer or an inorganic nanoparticle supplying nanoadditive comprising from 1 to 75 weight percent silicate layers or inorganic nanoparticles, preferably 20 to 50 weight percent silicate layers or inorganic nanoparticles, dispersed in a matrix of a second polymer or copolymer (of the same or different chemical constitution or molecular weight or tacticity from the first polymer or copolymer) of Mₙ ranging from 10,000 to 40,000 with polymer chains of the second polymer or copolymer ionically or covalently attached to the silicate layers or inorganic nanoparticles.

In a second embodiment, the invention herein is directed to a nanocomposite comprising a first polymer or copolymer having Mₙ ranging from 5,000 to 400,000 which is obtained by polymerizing one or more ethylenically unsaturated monomers and/or one or more olefins, blended with a nanoadditive comprising 1 to 75 weight percent silicate layers or inorganic nanoparticles and 99 to 25 weight percent of a second polymer or copolymer which is poly(ethylenically unsaturated monomer) or copolymer of two or more ethylenically unsaturated monomers or a copolymer of ethylenically unsaturated monomer and epoxide monomer (e.g., ethylene oxide) or caprolactone monomer (e.g., ε-caprolactone), e.g., polystyrene-b-polycaprolactone, and is of different chemical constitution from or a different molecular weight from or a different tacticity from the first polymer or copolymer and constitutes a dispersion of the silicate layers or inorganic nanoparticles in a matrix of said second polymer or copolymer where chains of the second polymer or copolymer are ionically or covalently attached to the silicate layers or inorganic nanoparticles, and the weight ratio of first polymer or copolymer to nanoadditive ranges from 20:1 to 1:1. The nanocomposite preferably contains 0.1 to 25.0% by weight silicate layers or inorganic nanoparticles. The nanocomposite very preferably contains 0.1 to 5.0% by weight silicate layers or inorganic nanoparticles. While the 0.1 to 5.0 weight percent range gave increased tensile strength, modulus and toughness, higher silicate layer or inorganic nanoparticle contents gave increased strength and modulus but lower toughness and/or elongation at break. Increased modulus is most important for scratch-resistant coatings, as in safety lenses and windshields. For the cases of increased modulus and increased toughness, an important application is flexible automotive coatings sometimes referred to as “unfinishes”; these coatings are hard enough for metal parts but sufficiently soft and tough for plastic parts and enable automobiles to be painted on the same assembly finish line and provide a finish that is strong but does not crack.

In an important case of the invention the nanoadditive comprises inorganic nanoparticles which are exfoliated silicate layers from a nanoclay and homopolymer or copolymer from ethylenically unsaturated monomer, with polymer chains in the nanoadditive being ionically attached to the exfoliated silicate layers which are dispersed in a matrix of the homopolymer or copolymer.

As used herein, the term “nanocomposite” means composition of nanoparticles in a polymer matrix.

As used herein, the term “nanoparticle” means a discrete amount having at least one dimension less than 10 nm.

The term “nanoclay” as used herein means clay having nanometer thickness silicate platelets that can be modified to make clay complexes compatible with organic monomers and polymers. The term “silicate layers” as used herein refers to the nanometer thickness silicate platelets.

The term “inorganic nanoparticle” as used herein means nanoparticle of mineral or metal and excludes silicate layers.

The term “nanoadditive” is used herein to mean a nanocomposite of nanoparticles in a polymer or copolymer where the nanoparticles are dispersed in a matrix of the polymer or copolymer, for use for blending with a different polymer or copolymer (i.e., the polymer or copolymer of the nanoadditive and the different polymer or copolymer, are of different or the same chemical constitution, different molecular weight or different tacticity). The nanoadditive may be referred to as a masterbatch.

The molecular weights herein are determined by gel permeation chromatography (GPC) using polystyrene standards unless otherwise stated.

### DETAILED DESCRIPTION

It has been discovered herein that the dispersion of the silicate layers or inorganic nanoparticles in the nanoadditive carries over to the nanocomposite made using the nanoadditive.

When the first polymer or copolymer is miscible with the polymer or copolymer of the nanoadditive (miscibility being shown or determined by prior art methods), the silicate layers or inorganic nanoparticles are present in the nanocomposite in single arrangement (that is not in bundles) with random orientation.

When the first polymer or copolymer is partly miscible with the polymer or copolymer of the nanoadditive (part miscibility being shown or determined by prior art methods), the silicate layers or inorganic nanoparticles are present in the nanocomposite, in a single arrangement with random orientation.

When the first polymer or copolymer is immiscible with the polymer or copolymer of the nanoadditive (immiscibility being shown and determined by prior art methods), the silicate layers or inorganic nanoparticles are present in the nanocomposite in single arrangement with random orientations and sometimes also in bundles of two or three silicate layers spaced, e.g., 6-8 nm apart.

We turn now to the nanoadditive.

The silicate layers on inorganic nanoparticles are preferably dispersed layers of silicate (about 1 nm in thickness) from nanoclay. The inorganic nanoparticles can also be, for example, carbon nanotubes. The term “carbon nanotube” means any material generated from the chemical potential difference between a catalyst and a carbon material, which is induced from a thermal decomposition process, the material also having a tube-like or cylinder-like shape and having a diameter of about 1 to 10 nm. The inorganic nanoparticles can also be nanosized (1-10 nm), in at least one dimension, metal clusters; the term “metal clusters” is used herein to mean any compound of a finite group of metal atoms participating in direct metal-metal bonds with a considerable overlap of binding orbitals.

The polymer or copolymer of the nanoadditive is from ethylenically unsaturated monomer(s) or from ethylenically unsaturated monomer and epoxide or from ethylenically unsaturated monomer and caprolactone monomer, and has Mₙ ranging from 10,000 to 40,000. The molecular weight of the polymer or copolymer of the nanoadditive is important because the molecular weight of the polymer or copolymer of the nanoadditive needs to be high enough to provide chain entanglement with chains of the first polymer or copolymer but low enough so that weight percentage of silicate layers or inorganic nanoparticles is high enough so the weight percentage of silicate layers or nanoparticles in the final product is high enough. Since the silicate/inorganic loading decreases as molecular weight of the polymer or copolymer of the nanoadditive goes up, the molecular weight of the polymer or copolymer of the nanoadditive must be low to obtain an appropriate degree of silicate/inorganic loading in the nanoadditive (preferably about 20 to 50 weight percent) so as to obtain an appropriate amount of silicate/inorganic in the final nanocomposite where the loading is diluted by the matrix polymer. Preferably, the silicate/inorganic loading in the final product is about 0.1 to 5 weight percent.

The homopolymer or copolymer of the nanoadditive is preferably from ethylenically unsaturated monomer(s). The ethylenically unsaturated monomer is, for example, selected from the group consisting of styrene, methyl methacrylate, tert-butyl methacrylate, tert-butyl-acrylate, n-butyl methacrylate, 2,2,3,3,3-pentafluoropropyl methacrylate and (2-trimethylsilyloxy)-ethyl-methacrylate. Suitable ethylenically unsaturated monomers include those set forth below:

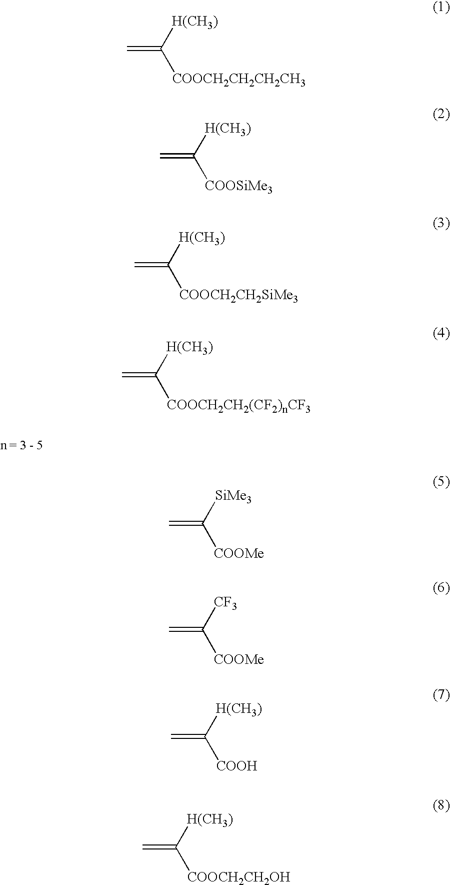

Where copolymers are obtained from ethylenically unsaturated monomer and epoxide or caprolactone, the epoxide is preferably ethylene oxide and the caprolactone is preferably ε-caprolactone.

When the nanoadditive comprises exfoliated silicate layers from a nanoclay and homopolymer or copolymer from monomer(s) comprising ethylenically unsaturated monomer with polymer chains in the nanoadditive being ionically attached to the exfoliated silicate layers which are dispersed in a matrix of the homopolymer or copolymer, the nanoadditive is preferably made by a method comprising photopolymerizing monomers comprising ethylenically unsaturated monomer in solvent containing photoinitiator-modified silicate or via bulk polymerization without solvent to cause living polymerization of the monomer(s) and ionic attachment of polymer or copolymer chains to exfoliated silicate layers. The preferred method referred to in the paragraph directly above, is carried out as follows: First, an admixture is formed comprising photoinitiator modified silicate or partially photoinitiator modified silicate said ethylenically unsaturated monomer and organic solvent. The admixture is positioned so that it receives ultraviolet irradiation (e.g., from a UV lamp), very suitably at room temperature. Preferably, the solvent is a polar aprotic solvent, very preferably, tetrahydrofuran, less preferably, dimethyl formamide, N-methyl pyrrolidone or dimethylsulfoxide, the weight ratios of monomer:photoinitiator modified silicate or partially photoinitiator modified silicate. Amounts and conditions are selected to give the required amount of silicate layers, e.g., 20 to 50 weight percent and Mₙ ranging from 10,000 to 40,000.

Photoinitiator modified silicate or partly photoinitiator modified silicate can be made by cation exchanging nanoclay in inorganic cation form with a photoinitiator for cation exchange attachment to a nanoclay comprising a photoinitiating moiety and a moiety for attaching to nanoclay by cation exchange or by partly cation exchanging the nanoclay in the inorganic cation form (a) with said photoinitiator and by partly cation exchanging the nanoclay with (b) organic cation which does not contain photoinitiating moiety where the mole ratio of a:b ranges from 10:1 to 1:10, e.g., from 2:1 to 1:2, e.g., is 1:1. The cation exchange is readily carried out, for example, by ultrasonicating a mixture of nanoclay in the sodium form in distilled water concurrently with or followed by stirring, e.g., at 50° C., then adding the photoinitiator comprising a photoinitiating moiety and an attaching moiety or that photoinitiator plus organic cation which is not a photoinitiator and stirring at room temperature to 50° C. for 30 to 48 hours and recovering and purifying the photoinitiator modified silicate or partially modified photoinitiator silicate. The nanoclay is preferably montmorillonite (a natural clay) or fluorohectorite or laponite (synthetic clays). Other useful nanoclays include bentonites, beidellites, hectorites, saponites, nontronites, sauconites, vermiculites, ledikites, magadiites, kenyaites and stevensites. The nanoclays are normally purchased in the sodium form. Exchanging the sodium with organic cation renders the nanoclay (silicate) more hydrophobic so the nanoclay is more readily swellable in organic media (so the silicate layers therein are more readily accessible to monomer) and renders the silicate layers more miscible with the polymer or copolymer of the nanoadditives. The photoinitiator for cation exchange attachment to nanoclay is preferably 4-(N,N-diethyldithiocarbamylmethyl)benzyltrimethyl ammonium bromide. This photoinitiator can be made by admixing 4-(bromomethyl)benzyltrimethy ammonium bromide (prepared as described in Rammo, J., et al., Chimica Acta 251, 125-134 (1996) and twice molar amount of N,N-diethyldithiocarbamate trihydrate and acetone and stirring at room temperature for 24 hours and separating and purifying the precipitate. The organic cation which does not contain photoinitiating moiety is preferably trimethyl benzyl ammonium from trimethylbenzyl ammonium chloride. The trimethylbenzyl ammonium chloride is commercially available. The preferred modified nanoclay is montmorillonite (sodium form) cation exchanged with the photoinitiator 4-(N,N-diethyldithiocarbamylmethyl) benzyltrimethyl ammonium bromide. The preferred partially modified nanoclay is montmorillonite (sodium form) partially cation exchanged with (a) said photoinitiator and partly cation exchanged with (b) trimethyl benzyl ammonium chloride; where the mole ratio of a:b is 1:1. In the case of copolymers from ethylenically unsaturated monomer and epoxide monomer, and from ethylenically unsaturated monomer and caprolactone monomer, hydroxyl group can be incorporated into the photoinitiator to enable polymerization of the epoxide or caprolactone simultaneously with the photoinitiator.

A specific example of making of nanoadditive with silicate content of 20.5 wt % in a polystyrene (Mₙ of 19,000) matrix is set forth in the beginning of Working Example I hereinafter. A specific example of making of nanoadditive of silicate content of 24.7% in a polystyrene (Mₙ of 24,300) matrix is set forth in Working Example II hereinafter. In each case silicate layers are ionically attached to polymer chains. In both cases scanning transmission electron microscopy (STEM) showed bundles of silicate layers parallel to one another with the d-spacing being about 6-8 nm and also single silicate layers with random orientations. Polymer or copolymer chains can be attached to carbon nanotubes or metal clusters by the same principle, i.e., the nanotubes or metal clusters are attached to an initiator by an ionic or covalent bond and then in situ polymerization is carried out. Thus the nanocomposites of the final product can include silicate layers or inorganic particles, which are initiator modified.

The first polymer or copolymer can widely vary and can be miscible with the polymer or copolymer of the nanoadditive or partly miscible with the polymer or copolymer of the nanoadditive or immiscible with the polymer or copolymer of the nanoadditive and can have Mₙ ranging, for example, up to 400,000. It can be poly(ethylenically unsaturated monomer) or poly(ethylenically unsaturated monomer-co-epoxide monomer) or poly(ethylenically unsaturated monomer-co-caprolactone monomer) as described above for the second polymer or copolymer but of different or the same constitution, molecular weight or tacticity, from the second polymer or copolymer. It can be polyolefin, e.g., polypropylene or polyethylene. When the polymer or copolymer of the nanoadditive is atactic polystyrene, examples of miscible first polymer or copolymer are, for example, poly(styrene-b-butadiene-b-styrene), polystyrene of a different molecular weight or poly(acrylate-b-butadiene-b-styrene). When the polymer or copolymer of the nanoadditive is atactic polystyrene, an example of partly miscible first polymer or copolymer is syndiotactic polystyrene. When the polymer or copolymer of the nanoadditive is atactic polystyrene, examples of immiscible first polymer or copolymer are isotactic polypropylene, and low-density polyethylene. When the polymer or copolymer of the nanoadditive is poly(n-butyl methacrylate), examples of first polymer or copolymer suitably used in conjunction therewith are poly(methyl methacrylate), poly(n-butyl methacrylate), poly(2-trimethylsiloxyethyl methacrylate), poly(2-hydroxyethyl methacrylate), poly(tert-butyl acrylate), poly(tert-butyl methacrylate), and copolymers made from any combination of acrylate and methacrylate esters.

We turn now to the making of the nanocomposite. The weight ratio of the first polymer or copolymer to nanoadditive that is blended ranges, for example, from 20:1 to 1:1.

We turn now to the solution blending of the first polymer or copolymer and the nanoadditive. A solvent is selected that will dissolve both the first polymer or copolymer and the polymer or copolymer of the nanoadditive, preferably that will dissolve these at room temperature or at least at a temperature less than 200° C. A solution of the first polymer or copolymer and of the polymer or copolymer of the nanoadditive is then formed in the solvent with the silicate layers or inorganic nanoparticles in homogenous dispersion therein because of their attachment to polymer chains, e.g., by adding chunks of first polymer or copolymer to the solvent and stirring until a clear solution is formed and then adding the nanoadditive and stirring until a homogenous solution (clear to somewhat cloudy at high silicate or inorganic loading) is formed and then drying.

We turn now to the melt blending of the first polymer or copolymer and the nanoadditive. A temperature is selected that will melt (but not decompose or cause crosslinking) both the first polymer or copolymer and the polymer or copolymer of the nanoadditive. The blending can be effected in an extruder at the selected temperature. The melt blending was found to give similar results to the solution blending.

The invention is illustrated by the following working examples.

### EXAMPLE I

Nanoadditive was prepared of matrix of atactic polystyrene of Mₙ 19,000 with silicate content of 20.5% as described below:

First, the photoinitiator 4-(N,N-diethyldithiocarbamylmethyl)benzyl trimethylammonium bromide was prepared as follows:

4-(N,N-diethyldithiocarbamylmethyl)benzyl trimethylammonium bromide (2). To a 1000-mL flask equipped with a stirring bar were added 4-(bromomethyl)benzyl trimethylammonium bromide (1) (prepared as described in Rammo, J., et al., Chimica Acta 251, 125-134 (1996) (8.60 g, 26.6 mmol), sodium N,N-diethyldithiocarbamate trihydrate (Aldrich) (12.0 g, 53.3 mmol), and acetone (200 mL). The mixture was stirred at room temperature for 24 hours. A white precipitate formed gradually. The precipitate was filtered and washed with technical acetone (500 mL×3). By-product NaCl can be removed as a solid by extraction with dry CHCl₃ for five hours. The white powder product was dried in a vacuum oven overnight. Yield: 10.4 g, (98.0%). ¹H NMR: δ (DMSO-d₆) 1.14-1.20 (m, 6H), 2.98 (s, 9H), 3.70-3.72 (q, 2H), 3.94-3.96 (q, 2H), 4.47 (s, 2H), 4.56 (s, 2H), 7.44-7.52 (q, 4H).

Then photoinitiator 2 modified montmorillonite (MMT) was prepared as follows:

A mixture of 4.97 g of montmorillonite in the sodium form (Cloisite® Na⁺, 92 meq/100 gm clay of cation exchange capacity—CEC—; Southern Clay Products, Gonzeles, Tex.), in 500 mL of distilled water was ultrasonicated overnight and stirred for one hour. 2.0 g of 4-(N,N-diethyldithiocarbamylmethyl)benzyl trimethylammonium bromide prepared as described above, in 100 mL of distilled water was added. The reactive mixture was stirred for 48 h at RT and the resultant photoinitiator modified montmorillonite became a precipitate in water. The modified montmorillonite was obtained after filtration; washed with water till no precipitate was formed when 0.1 N of AgNO₃ aqueous solution was added to the filtrate; and freeze-dried. The loading of the organic photoinitiator component was 15.5% by weight based on the weight loss of the modified montmorillonite on TGA.

Nanoadditive was then prepared as follows:

To a 3-neck round bottom flask equipped with a stirring bar were added the desired amounts of the photoinitiator modified silicate, styrene monomer, and THF (200 mL). Nitrogen gas was bubbled into the mixture with stirring for 30 min. A UV lamp positioned 10 cm away from the flask was turned on and left on for 48 hours. The temperature of the reaction flask was kept around room temperature by the air flow in the hood. Nitrogen gas was kept on throughout the whole process. At the end of the polymerization, the UV lamp was turned off and the mixture was diluted with THF (about 150 mL). The product was precipitated into methanol (10-fold excess). The white solid was filtered and dried in a vacuum oven. The amount of photoinitiator modified silicate was 1.70 grams and the amount of styrene was 20.0 mL. Results obtained were as follows; 48.1%, yield, Mₙ (CAL)×10⁻³ was 9.5, Mₙ (SEC)×10⁻³ was 19.0, PDI was 1.54 and wt percent silicate was 20.5. The Mₙ (CAL) was calculated based on monomer conversion and equivalent of initiator sites. Mₙ (SEC) and PDI were determined by size exclusion chromatography (SEC) using a Waters HPLC with Ultrastyrogel (Waters Associates) columns; retention times were converted to polymer molecular weights using a calibration curve built from narrow molecular weight distribution polystyrene standards. The wt percent silicate was determined by TGA under N₂ on a Seiko thermogravimetric differential thermal analyzer using a heating rate of 5.0° C./min.

STEM of the composition showed bundles of silicate layers parallel to one another with d-spacing of about 6-8 nm, and also single silicate layers with random orientation; this indicates the silicate layers are dispersed in the sample. Polystyrene polymer chains were ionically attached to the silicate layers.

Solution blending was carried out of purchased poly(styrene-b-butadiene-b-styrene) (SBS), average M_{w} of about 140,000 (SEC), with 30 wt % styrene, and the nanoadditive in toluene as follows:

To a 1-L round bottom flask equipped with a stirring bar were added commercial SBS chunks (amounts indicated in Table 1 below). For each gram of SBS, 60 μL of toluene was added. The mixture was stirred at room temperature for 2 hours upon which a clear solution formed. The PS silicate nanocomposite (amounts indicated in Table 1 below) was added to the solution. The mixture was further stirred at room temperature for 30-60 minutes until a homogenous solution was obtained. The toluene was removed by rotavap. The solid residue was dried under vacuum at room temperature for 24 hours to give a clear film.

For comparison, SBS control was also prepared using the same procedure, only without adding the PS silicate nanocomposites.

TABLE 1

| | Nano- | | Silicate | Silicate | |
|---|---|---|---|---|---|
| | additive | SBS | content^{a} | content^{b} | PS content^{c} |
| Entry | (g) | (g) | (TGA, wt %) | (CAL, wt %) | (wt %) |
| Nano- | — | — | 20.5 | — | 79.5 |
| additive | | | | | |
| SBS1 | 1.00 | 15.00 | 1.8 | 1.3 | 7.0 |
| SBS2 | 2.00 | 15.00 | 2.8 | 2.4 | 10.9 |
| SBS3 | 2.00 | 7.00 | 4.9 | 4.6 | 19.0 |
| SBS control | — | — | — | — | — |

^{a}Determined by TGA under N₂ on a Seiko thermogravimetric differential thermal analyzer using a heating rate of 5.0° C./min.
^{b}Calculated based on material added.
^{c}Polystyrene that comes from polystyrene silicate nanocomposite masterbatch. Estimated based on two sets of values. 1) silicate content of PS silicate nanocomposites is 20.5%. 2) silicate contents of each SBS silicate nanocomposites determined by TGA.

Solution blending was preferred to melt blending because SBS crosslinks easily at high temperatures.

In each case nanocomposite product was obtained with SBS matrix and silicate dispersed therein in single silicate layers with random orientations. There was the absence of the bundles of silicate layers originally present in the nanoadditive.

SBS controls and SBS nanocomposite exhibited the same thermal stability.

The nanocomposites showed higher storage moduli compared with the SBS control over almost the entire temperature range (−100° C. to 160° C.). The higher the silicate content was, the higher the storage modulus was. The enhancement increased with increasing temperature with the greatest improvement occurring at 120° C. The plateau moduli were well defined and preserved for all the nanocomposites.

### EXAMPLE II

Nanoadditive was prepared of matrix of atactic polystyrene (aPS) of Mₙ 24,300 and silicate content of 24.7% by the method of Example I except that the amount of photoinitiator modified silicate was 1.60 grams and the amount of styrene was 20.0 mL.

STEM of the nanoadditive composition showed bundles of silicate layers parallel to one another with d-spacings of about 6-8 nm, and also single silicate layers with random orientations; this indicates that the silicate layers are dispersed in the sample. Polystyrene polymer chains were ionically attached to the silicate layers.

Solution blending was carried out of purchased syndiotactic polystyrene (sPS) (average Mₙ of 250,000 with broad molecular weight dispersion, syndiotactic content higher than 90%) and the nanoadditive in trichlorobenzene at 190° C. as follows with the reactive amounts and results indicated in Table 2 below.

The solution blending was carried out as follows:

To a 1-L round bottom flask equipped with a stirring bar and a condenser were added commercial sPS chunks (amounts indicated in Table 2 below). For each gram of sPS, 100 mL of 1, 2, 4-trichlorobenzene was added. The mixture was stirred at 190° C. for 2 hours to give a clear solution. The PS silicate nanoadditive (amounts indicated in Table 2 below) was added to the solution. The mixture was further stirred at 190° C. for 30-60 minutes until a homogenous solution was obtained. The solution was poured into methanol (10-fold excess). A white solid was formed and filtered. The white polymeric material was dried in a vacuum oven at ˜100° C. for 24 hours.

Amounts and results are indicated in Table 2 below:

TABLE 2

| | Nano- | | Silicate | Silicate | aPS |
|---|---|---|---|---|---|
| | additive | sPS | content^{a} | content^{b} | content^{c} |
| Entry | (g) | (g) | (TGA, wt %) | (CAL, wt %) | (wt %) |
| Nano-additive | — | — | 24.7 | — | 75.3 |
| sPS1 | 0.10 | 1.00 | 2.2 | 2.2 | 6.7 |
| sPS2 | 0.20 | 1.00 | 3.9 | 4.1 | 11.9 |
| sPS3 | 0.30 | 1.00 | 5.5 | 5.7 | 16.8 |

^{a}Determined by TGA under N₂ on a Seiko thermogravimetric differential thermal analyzer using a heating rate of 5.0° C./min.
^{b}Calculated based on material added.
^{c}aPS is the polystyrene coming from polystyrene silicate nanoadditive. The values were estimated based on two sets of values. 1) silicate content of PS silicate nanoadditive is 24.7%. 2) silicate contents of each sPS silicate nanocomposites determined by TGA.

XRD and STEM of nanocomposite product showed that the silicate was dispersed in the syndiotactic polystyrene matrix into single layers with random orientations.

### EXAMPLE III

The same nanoadditive was used as in Example II.

Solution blending was carried out of commercial polypropylene pellets (isotactic polypropylene, mp 160-165° C., density of 0.900, melt index of 0.5 g/10 min (230° C./21.6 kg, ASTM D 1238) and the nanoadditive in xylene at elevated temperatures as described below.

To a 1-L round bottom flask equipped with a stirring bar and a condenser were added commercial polypropylene (PP) pellets (amounts indicated in Table 3 below). For each gram of PP, 100 mL of xylene was also added. The mixture was stirred at 190° C. and maintained at this temperature with the stirring kept on until a clear solution was achieved. The polystyrene (PS) silicate nanoadditives (amounts indicated in Table 3 below) was then added to the solution. The mixture was stirred at 150° C. for 30-60 minutes to give a homogenous solution. The solution was then poured into methanol (10-fold excess). A white solid was formed, filtered and dried in a vacuum oven at ˜60° C. for 24 hours.

For comparison, neat PP samples were prepared using the same procedure, only that PS silicate nanoadditive was not added.

Amounts and results are set forth in Table 3 below.

TABLE 3

| | Nano- | | Silicate | Silicate | PS |
|---|---|---|---|---|---|
| | additive | PP | content^{a} | content^{b} | content^{c} |
| Entry | (g) | (g) | (TGA, wt %) | (CAL, wt %) | (wt %) |
| Nano-additive | — | — | 24.7 | — | 75.3 |
| PP1 | 1.00 | 15.00 | 2.4 | 1.5 | 7.3 |
| PP2 | 2.00 | 15.00 | 3.8 | 2.9 | 11.6 |
| PP3 | 2.00 | 7.50 | 4.7 | 5.2 | 14.3 |
| PP control | — | — | — | — | — |

^{a}Determined by TGA under N₂ on a Seiko thermogravimetric differential thermal analyzer using a heating rate of 5.0° C./min.
^{b}Calculated based on material added.
^{c}Estimated based on two sets of values. 1) silicate content of PS silicate nanocomposites is 24.7%. 2) silicate contents of each polypropylene silicate nanocomposites determined by TGA.

STEM of injection molded nanocomposite showed both bundles of two or three layers of silicate with the interlayer distance between silicate layers being about 1.5 nm and single silicate layers with interlayer distances of greater than 10 nm showing dispersion of silicate layers in the polypropylene matrix.

All the nanocomposites had higher storage modulus than polypropylene control over the entire temperature range investigated, and the higher the silicate content, the higher the storage modulus. Thermostability of the nanocomposite remained close to that of the polypropylene control. Compared to the polypropylene control, the nanocomposites had the same melting and crystallization temperatures.

Melt blending of the nanocomposites and the isotactic polypropylene gave similar results.

### EXAMPLE IV

The same nanoadditive was used as in Example II. Solution blending was carried out of commercial low density polyethylene (LDPE) (mp 104-105° C., d 0.918, melt index 7 g/10 min (190° C./2-16 kg, ASTM D1238) and the nanoadditive, in toluene at 85° C. as described below:

To a 1-L round bottom flask equipped with a stirring bar and a condenser were added commercial LDPE pellets (15.00 or 7.00 g as indicated in Table 4 below). For each grant of LDPE, 60 mL of toluene was added. The mixture was stirred to 85° C. and maintained at this temperature with the stirring until a clear solution was obtained. The PS silicate nanoadditive (amounts indicated in Table 4 below) was then added. The mixture was stirred at 85° C. for 30-60 minutes resulting in a homogenous solution. The solution was then poured into methanol (10-fold excess). A white solid was formed and was filtered. The white polymer was dried in a vacuum oven at −60° C. for 24 hours.

For comparison, neat LDPE control was also prepared using the same procedure in absence of the PS silicate nanoadditive.

Amounts and results are set forth in Table 4 below.

TABLE 4

| | Nano- | | Silicate | Silicate | PS |
|---|---|---|---|---|---|
| | additive | LDPE | content^{a} | content^{b} | content^{c} |
| Entry | (g) | (g) | (TGA, wt %) | (CAL, wt %) | (wt %) |
| Nano-additive | — | — | 24.7 | — | 75.3 |
| PE1 | 0.50 | 15.00 | 1.1 | 0.8 | 3.4 |
| PE2 | 2.00 | 15.00 | 2.6 | 2.9 | 7.9 |
| PE3 | 2.00 | 7.50 | 4.9 | 5.2 | 14.9 |
| PE control | — | — | — | — | — |

^{a}Determined by TGA under N₂ on a Seiko thermogravimetric differential thermal analyzer using a heating rate of 5.0° C./min.
^{b}Calculated based on material added.
^{c}Estimated based on two sets of values. 1) silicate content of PS silicate nanoadditive is 24.7%. 2) silicate contents of each polyethylene silicate nanocomposites determined by TGA.

STEM of nanocomposite product showed that a majority of the silicate layers in the LDPE matrix are dispersed in single layers with random orientations.

Thermal stability and crystallization and melting behavior are described below:

The nanoadditive started to decompose around 320° C. The LDPE silicate nanocomposite did not start to decompose until about 420° C. For the nanocomposite with 1.1% silicate, the degradation curve almost overlapped that of LDPE control. With increased silicate content, and therefore increased PS content, the onset of degradation shifts further away from that of LDPE control toward that of the nanoadditive. It is clear that the presence of larger amount of PS imparts some thermal instability to the nanocomposites. For the LDPE nanocomposite with 4.9% silicate, the onset of degradation was about 20° C. lower than that of the LDPE control. Hence, it is critical to maintain a low level of PS. But because all the onset of decomposition temperatures are considerably higher than the processing temperature of LDPE (˜120° C.), the use of the nanocomposite should not be adversely affected.

The melting temperatures of the nanocomposites were the same as that of the LDPE control. However, the crystallization temperatures were about 2° C. lower than that of the control. In addition, the crystallinity of the as made nanocomposite was lower than that of the control.

The nanocomposite had higher storage modulus than the LDPE over the entire temperature range investigated, and the higher the silicate content was, the higher the storage modulus was.

### EXAMPLE V

The nanoadditive was poly(n-butyl methacrylate) (PnBMA) matrix with well exfoliated montmorillonite (MMT) therein with the polymer chains being ionically attached to the silicate layers. The nanoadditive was used as a masterbatch in the preparation of other nanocomposites. The polymer silicate nanocomposites with MMT content varying from 1.5 wt % to 40 wt %, were obtained and characterized by TGA, DSC, GPC, NMR, XRD, TEM and mechanical properties measurements by Instron. Compared to the commercial PnBMA, the thermal stability of PnBMA silicate nanocomposites greatly increased by 100-150° C. Results are set forth in Table 5 below:

TABLE 5¹

| | | Maximum | | | |
|---|---|---|---|---|---|
| | | Percent | Modulus | Tensile | |
| | | Strain | (Young) | Stress | Toughness |
| Entry | Materials | (%) | (MPa) | (MPa) | (MPa) |
| 1 | Control² | 304.4 | 287.8 | 17.6 | 35.6 |
| 2 | NC blending³ | 299.5 | 399.8 | 21.5 | 42.5 |
| | (1.5 wt % | | | | |
| | MMT) | | | | |
| 3 | NC⁴ | 76.5 | 584.3 | 26.2 | 10.0 |
| | (8.6 wt % | | | | |
| | MMT) | | | | |
| 4 | NC⁴ | 298.7 | 348.7 | 20.9 | 38.8 |
| | (4.2 | | | | |
| | wt % MMT) | | | | |

¹The film samples were measured at 70 F. with 65% of humidity; the samples were stored for 3 days before measurement.
²The control sample is the commercial PnBMA with M_{w(GPC)} ~337,000 after purification by precipitation in MeOH from THF solution of PnBMA.
³The blending with overall 1.5 wt % of MMT consists of PnBMA silicate nanoadditive (40 wt % MMT, M_{nGPC} = 10,710, PDI = 1.7) and the purified commercial PnBMA
⁴PnBMA silicate nanoadditive consisting of PnBMA of M_{n(GPC)} = 30,300, PDI = 1.6 and 40 wt % silicate blended with commercial purified PnBMA.

The incorporated MMT layers in nanometer sizes at levels of 1.5 wt % and 4.2 wt % in the nanocomposite did not only improve modulus and tensile stress, but also improved the toughness of the obtained PnBMA silicate nanocomposites. At over 8% silicate toughness did not increase.

### Variations

The foregoing description of the invention has been presented describing certain operable and preferred embodiments. It is not intended that the invention should be so limited since variations and modifications thereof will be obvious to those skilled in the art, all of which are within the spirit and scope of the invention.

What is claimed is:

1. A method of preparing a nanocomposite comprising from 0.1 to 25% by weight silicate layers or inorganic nanoparticles dispersed in a matrix of first polymer or copolymer of Mₙ ranging from 5,000 to 400,000, said method comprising the steps of melt blending or solution blending the first polymer with a nanoadditive comprising from 20 to 50 weight percent silicate layers or inorganic nanoparticles dispersed in a matrix of a second polymer or copolymer of Mₙ ranging from 10,000 to 40,000 with polymer chains of the second polymer or copolymer being attached to the silicate layers or inorganic nanoparticles.

2. The method of claim 1 where the weight ratio of first polymer or copolymer and nanoadditive that are blended ranges from 20:1 to 1:1.

3. The method of claim 2 where the nanoadditive comprises exfoliated silicate layers from a nanoclay and homopolymer or copolymer from ethylenically unsaturated monomer with polymer chains in the nanoadditive ionically attached to the exfoliated silicate layers, which are dispersed in a matrix of the homopolymer or copolymer.

4. The method of claim 3 where the homopolymer or copolymer of the nanoadditive is atactic polystyrene and the silicate layers of the nanocomposite are parallel to one another in bundles with d-spacing of about 6-8 nm and/or are single silicate layers with random orientations.

5. The method of claim 4 where the first polymer is poly(styrene-b-butadiene-b-styrene) and the silicate is dispersed into single silicate layers with random orientation in the nanocomposite and there is the absence of the bundles of silicate layers originally present in the nanoadditive.

6. The method of claim 4 where the first polymer comprises syndiotactic polystyrene and the silicate layers are dispersed in the nanocomposite in single layers with random orientations.

7. The method of claim 4 where the first polymer is isotactic polypropylene and the nanocomposite after injection molding contains both bundles of two or three layers of silicate with the interlayer distance between the silicate layers being about 1.5 nm and single silicate layers with interlayer distances greater than 10 nm.

8. The method of claim 4 where the first polymer is low density polyethylene and a majority of the silicate layers in the nanocomposite are dispersed into single layers with random orientations.

9. The method of claim 4 where the homopolymer or copolymer of the nanoadditive is poly(n-butyl methacrylate).

10. Nanocomposite comprising a first polymer or copolymer having Mₙ ranging from 5,000 to 400,000 which is obtained by polymerizing one or more ethylenically unsaturated monomers and/or one or more olefins, blended with a nanoadditive comprising 1 to 75 weight percent silicate layers or inorganic nanoparticles and 99 to 25 weight percent of a second polymer or copolymer which is poly(ethylenically unsaturated monomer) or a copolymer of two or more ethylenically unsaturated monomers or a copolymer of ethylenically unsaturated monomer and an epoxide monomer or a copolymer of ethylenically unsaturated monomer and a caprolactone monomer and is of different chemical constitution from or of different molecular weight from or of different tacticity from the first polymer or copolymer and constitutes a dispersion of the silicate layers or inorganic nanoparticles in a matrix of said second polymer or copolymer where chains of the second polymer or copolymer are ionically or covalently attached to the silicate layers or inorganic nanoparticles, and the weight ratio of first polymer or copolymer to nanoadditive ranges from 20:1 to 1:1.

11. The nanocomposite of claim 10, where the silicate layers or inorganic nanoparticles are initiator modified.

12. The nanocomposite of claim 11 where the nanoadditive is constituted of polymer chains attached to modified silicate.

13. The nanocomposite of claim 10 containing from 0.1 to 25% by weight silicate layers or inorganic nanoparticles.

14. The nanocomposite of claim 13 containing from 0.1 to 5.0% by weight silicate layers inorganic nanoparticles.
